(19) United States
(12) Patent Application Publication
(10) Pub. No.: US 2015/0019516 A1
(43) Pub. Date: Jan. 15, 2015

(54) Providing Durability of In-Memory Columnar Datastores Using Multile Logs

(71) Applicants: David WEIN, Saint Paul, MN (US); Anil GOEL, Waterloo (CA); Colin FLORENDO, Marlborough, MA (US)

(72) Inventors: David WEIN, Saint Paul, MN (US); Anil GOEL, Waterloo (CA); Colin FLORENDO, Marlborough, MA (US)

(21) Appl. No.: 13/937,769

(22) Filed: Jul. 9, 2013

(51) Int. Cl. G06F 17/30

(52) U.S. Cl. CPC G06F 17/30371
USPC 707/703

(57) ABSTRACT

Embodiments described herein generally relate to providing durability of in memory columnar datastores using multiple logs. A computer-implemented method is described. The method includes receiving a request to perform a transaction involving multiple tables in a column-oriented database system. The method further includes performing the transaction on each of the two or more database tables. Performance of the transaction generates two or more commit fragments corresponding to each of the two or more database tables. The method further includes writing each commit fragment to a transaction log for each of the two or more database tables. The method also includes writing a commit record for the transaction to a commit log after all commit fragments have been written.

### BACKGROUND

1. Field

Embodiments described herein generally relate to transaction logging for in-memory columnar datastores.

2. Background

Many database systems store tables of data as rows, each row having multiple fields, or columns. Other database systems store tables of data as columns, otherwise known as column-oriented database management systems (DBMS). Row-oriented database management systems are typically well suited for workloads that involve many transactions (i.e., inserts and deletes of single or multiple rows), while column-oriented database management systems are well suited for workloads that require queries that operate over a large set of data.

However, applications employing column-oriented databases still require transactional functionality. To preserve both the high-performance nature of these applications and the integrity of the database, efficient logging is required.

### BRIEF SUMMARY

Briefly stated, embodiments include system, method, and computer program product embodiments, and combinations and sub-combinations thereof, for providing durability of in-memory columnar datastores using multiple logs.

In an embodiment, a computer-implemented method in a database system is disclosed. The method includes receiving a request to perform a transaction involving multiple tables in a column-oriented database system. The method further includes performing the transaction on each of the two or more database tables. Performance of the transaction generates two or more commit fragments corresponding to each of the two or more database tables. The method further includes writing each commit fragment to a transaction log for each of the two or more database tables. The method also includes writing a commit record for the transaction to a commit log after all commit fragments have been written.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS

The accompanying drawings, which are incorporated herein and form part of the specification, illustrate various exemplary embodiments and, together with the description, farther serve to explain various underlying principles and enable a person skilled in the relevant art to make and use the disclosed embodiments.

FIG. 1 is a diagram illustrating a database system, in accordance with an exemplary embodiment.

FIG. 2 is a flow diagram illustrating a method for logging transactions in accordance with an embodiment.

FIG. 3 is a diagram illustrating logging transactions in accordance with an embodiment.

FIG. 4 is a flow diagram illustrating a method of building a list of transactions for recovery, in accordance with an embodiment.

FIG. 5 is a diagram illustrating a computer system, in accordance with an embodiment.

The following description makes reference to the accompanying drawings. Generally, like reference numbers indicate identical and/or functionally similar elements. Additionally, in general, the left-most digit of a reference number will identify the drawing in which the reference number first appears.

### DETAILED DESCRIPTION

### Introduction

The following detailed description refers to the accompanying drawings to illustrate various exemplary embodiments. Other embodiments are possible, and modifications can be made to the embodiments within the spirit and scope of this disclosure. It will be apparent to one of skill in the art that such embodiments can be implemented in different embodiments of software, hardware, firmware, and/or processing unit. Any code or syntax used to describe embodiments does not limit such embodiments to specialized hardware, firmware, software, or processing unit capable of executing such code or syntax. Furthermore, the operational behavior of such embodiments will be described herein with the understanding that various modifications and variations of the embodiments are possible.

Any reference to modules in this specification and the claims means any combination of hardware or software components for performing the intended function. A module need not be a rigidly defined entity, such that several modules may overlap hardware and software components in functionality. For example, a module may refer to a single line of code within a procedure, the procedure itself being a separate module. One skilled in the relevant arts will understand that the functionality of modules may be defined in accordance with a number of stylistic or performance-optimizing techniques, for example.

Embodiments provide for efficient logging of transactions of in-memory databases in a high performance column-oriented database system. One non-limiting example of a column-oriented database system is Sybase IQ from Sybase, Inc. of Dublin, Calif. In-memory databases utilize techniques such as parallelism, cache efficiency, and reduced lock algorithms to fully exploit performance. However, many use cases of these in-memory databases require “ACID” (Atomicity, Consistency, Isolation, and Durability) transaction durability, and thus require that the transactions are recoverable in the event of a system crash.

Providing durability and recoverability can degrade or erode the write performance advantages that an in-memory database provides over traditional disk-based databases. For example, traditional transaction log durability solutions tend to be inefficient in their use of caches and locks, and are serial in nature instead of exploiting parallelism. For example, typical databases have one transaction log, which may limit performance for queries and operations that utilize multiple tables.

The example Sybase IQ database system mentioned previously can be extended by adding an in-memory store as a companion to its disk-based main store. The disk-based main store is typically used for large data loads (often exceeding 1 terabyte (TB)). Meanwhile, the in-memory data store can allow for smaller data loads that would be inefficient in the main store. Further, the in-memory data store can allow concurrent transactions and exploit hardware parallelism. These benefits, however, still require maintenance of transaction durability. Accordingly, embodiments provide for efficient logging of transactions without major performance drawbacks.

### Logging System Optimizations

Providing an efficient logging system in accordance with an embodiment is accomplished in part using three optimizations. First, cache efficiency is maintained by logging data as “column vectors” as data is moved from memory into the disk-based data store. Cache efficiency is thus high because this copy occurs immediately after an input buffer has been moved into the data store.

Second, parallelism is maintained by assigning each table its own logical transaction log. Thus, writes to different tables do not collide within the logging system. Additionally, the log is locked only long enough to reserve space on the log page, and the log is not locked for the entire copy into the log. Accordingly, multiple threads attempting to write into the same log simultaneously have only a very narrow window of serialization.

Third, logging is minimized. Transaction logs, in accordance with an embodiment, are data change logs only. Thus, they only log data modifications, and not physical or physiological changes to the datastore. This significantly reduces the complexity of logging, and improves the efficiency of run time modifications to the physical structure of the store.

These optimizations, however, introduce new challenges to ensuring efficient logging. One of the largest difficulties is atomic commits. An atomic commit represents a single point in time where a transaction can be considered to be complete and recoverable in the event of a system crash. Thus, for example, if an insert operation is performed and an atomic commit is persisted (i.e., written to disk), if a subsequent crash occurs, the data corresponding to the atomic commit is still present in the database. If necessary, the transaction can be redone during recovery. Transactions that span multiple tables thus have log records in multiple transaction log streams. Each log stream corresponds to a single table. All logs must be persisted (i.e. flushed to disk), or the transaction cannot be considered durable.

One solution to the atomic commit issue involves the use of a two-phase commit protocol. Each table in the database has a respective transaction log. A client may request that a transaction be performed that spans two tables, e.g. table 1 and table 2. In the two-phase commit protocol, for a transaction that spans two tables, a “prepare” record is written to the transaction log stream of each of table 1 and table 2. Once the prepare records are written, a third resource referred to as the transaction manager writes the actual commit record into the transaction log of the transaction manager. If the system crashes before the transaction manager can write the commit to the transaction log, the transaction cannot be considered as completed.

The two-phase commit protocol, however, requires two different synchronous periods. Each synchronous period contributes to the latency experienced in the database system. In the two-phase commit protocol, each “prepare” record must first be written to disk (the first synchronous period). These “prepare” records can be written in parallel. Second, the commit itself can be written to disk (the second synchronous period). Once the commit record is written, the transaction can be acknowledged to a requesting client.

Some embodiments described herein eliminate the need for a separate transaction manager, thereby only requiring one synchronous period. Accordingly, latency is reduced by a factor of two.

### Database System

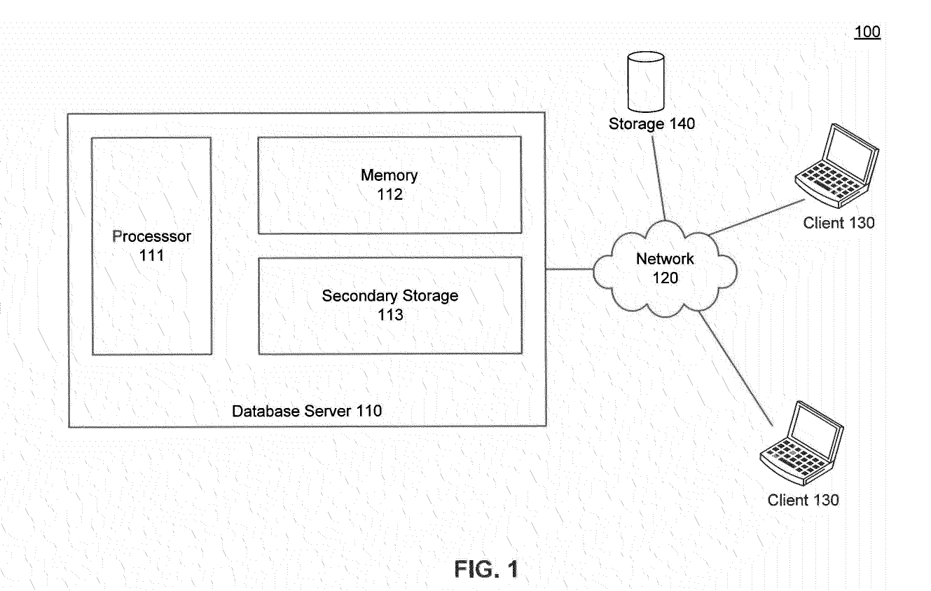

FIG. 1 is a diagram illustrating a system 100 in accordance with an embodiment. System 100 includes database server 110. Database server 110 may be, in an embodiment, a database server running database management server software such as Sybase IQ. Database server 110 may be implemented using at least one processor 111, and may also possess main memory 112 in the form of random access memory (RAM) and secondary storage 113, such as hard disk drive or solid-state drive storage. Database server 110 may include multiple processors 111, each processor having multiple cores. Database server 110 may be used for one or more databases, each database having one or more tables.

As shown in FIG. 1, database server 110 is connected over a network 120 to one or more clients 130. Network 120, in an embodiment, is a local area network (LAN). Network 120 may be wired, wireless, or a combination of the two. In an embodiment, network 120 may also be a wide area network (WAN) such as the Internet. Database server 110 may also be connected over network 120 to one or more storage devices 140.

### Commit Fragments

In an embodiment, commit fragments are used to log transactions that span multiple tables, and thus multiple log streams. At commit time, a commit record is logically broken up into commit fragments, with one commit fragment going into each log stream that must be flushed to disk as part of the commit. During the “prepare” phase, the physical commit is performed by appending a commit fragment to each log stream involved in the transaction. The log streams are then written in parallel to disk. Once these writes are complete, the commit is complete. At this point, the completion of the transaction can be acknowledged to a requesting client.

In an embodiment, each commit fragment for a given transaction is aware of other commit fragments for that transaction. This information assists in the recovery process, which is described herein.

In an embodiment, after all commit fragments for a transaction are written, a commit record for the transaction is written to a commit log stream. Writing to the commit log stream may be done in a lazy fashion, such that the commit log stream writes do not block other transactions. The use of the commit log stream is further described below.

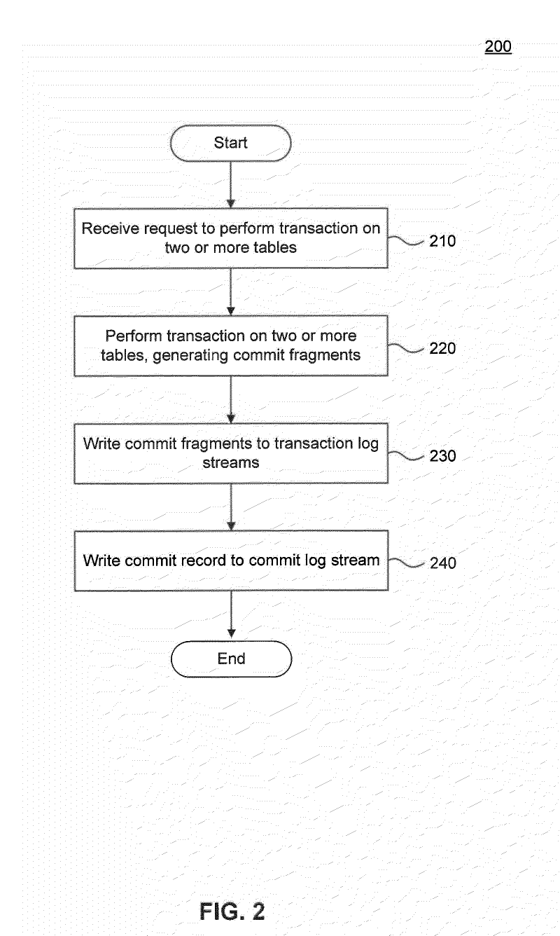

FIG. 2 is a flow diagram of a method 200 for performing logging in a database system. Method 200 may be implemented by, for example and without limitation, database server 110 of FIG. 1. Method 200 begins at step 210.

At step 210, a request to perform a transaction is received. The request is received from a client. The transaction requires two or more database tables in an in-memory column-oriented data store. In an embodiment, the transaction may be one of an insert, modify, or delete operation.

At step 220, the transaction is performed on the two or more tables in the in-memory data store. Performance of the transaction generates commit fragments for each table that is affected by the transaction. Thus, for example, if the transaction requires tables 1, 2, and 3, performance of the transaction generates three commit fragments.

At step 230, each commit fragment is written to a transaction log stream for each of the two or more database tables. In an embodiment, these writes are done in parallel, as they do not require the same log stream. Moreover, each log stream write can be performed by a separate processor or processor core in a multi-core processor. In an embodiment, after all commit fragments for the transaction are written, the transaction can be acknowledged to the requesting client. In an embodiment, commit fragments are written to disk based storage devices. Commit fragments may be written to disk based storage devices as part of a periodic flush (to disk) of the transaction log streams.

At step 240, a commit record for the transaction is written to a commit log stream. The commit log stream is written to after each commit fragment is written to the table-based transaction log streams. Writes to the commit log do not block other transactions. In an embodiment, the commit record is written to a disk based storage device.

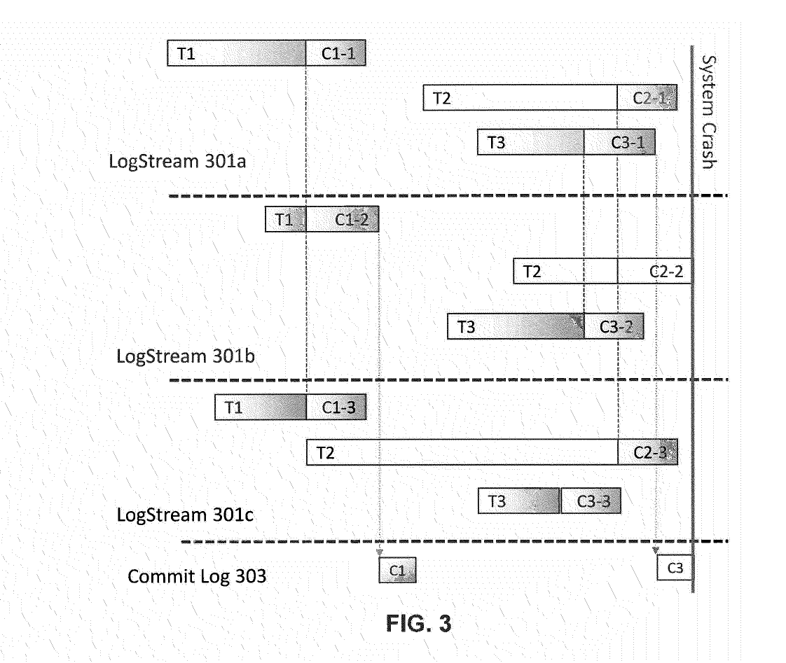

FIG. 3 is an example timeline illustrating method 200 during operation of a database system. FIG. 3 shows three log streams 301a, 301b, and 301c, each of which corresponds to a database table. FIG. 3 also shows commit log stream 303.

A request is received from a client to perform transaction T1. As shown in FIG. 3, transaction T1 requires three tables. The transaction is thus performed on each of the three tables, in accordance with step 220. When the transaction is complete, commit fragments C1-1, C1-2, and C1-3 are written to each of log streams 301a, 301b, and 301c, respectively, in accordance with step 230.

After each commit fragment C1-1, C1-2, and C1-3 is written to its respective log stream, commit C1 is written to the commit log stream, in accordance with step 240.

With respect to transaction T2, only commit fragments C2-1 and C2-3 are written to their respective log streams before the system crash occurs. Additionally, with respect to transaction T3, commit fragments C3-1, C3-2, and C3-3 are written to their respective log streams before the system crash, but commit C3 is not written to the commit log stream before the system crash occurs. These transactions and commit fragments are described in further detail below.

### Recovery

One of the goals of efficient logging, as noted above, is ensuring recoverability of the database system. In traditional disk-based database systems, after a system crash, much of the data is still on the disk, and only the portion of data that had not been written to disk before the crash must be recovered. Such disk-based database systems do not offer the performance of in-memory database systems, however.

In contrast, though in-memory database systems are fast, memory is erased upon a system crash or re-start. Thus, if such an event occurs, the memory is empty and the database tables must be reconstructed from scratch. This reconstruction process is known as recovery, and can take a large amount of time depending on the size of the in-memory database.

Recovery in an in-memory database system usually involves three phases. In the first phase, analysis, the transaction log is analyzed to determine what records exist in the log, and what work needs to be performed to recover the database. Thus, the analysis phase identifies transactions that must be rolled back (those that occurred between the last checkpoint and the system crash). In the second phase, redo, the database system redoes any operations identified in the analysis phase that were performed between the last time data was persisted to disk (i.e. the checkpoint), and the system crash. In the third phase, undo, the transactions that must be rolled back are undone.

In an in-memory database, the analysis phase can take a significant amount of time. Since the in-memory database must be rebuilt from scratch, the transaction log can be very large. In an embodiment, a separate log is created for the analysis phase, which speeds up the analysis phase, thereby making the recovery process quicker. The log for the analysis phase is created using the transaction logs and commit log described herein.

As described above, the commit log contains records of committed transactions. The commit log contains nearly all transactions that must be redone, but because the commit log is written to in a lazy fashion, it may not contain every transaction that must be redone. The transaction logs contain all transactions that must be redone, based on complete sets of commit fragments, but because multiple transaction logs exist, it may be inefficient to scan all transaction logs. Accordingly, in an embodiment, both the commit log and the transaction logs are used to build a list of transactions to redo in an efficient manner.

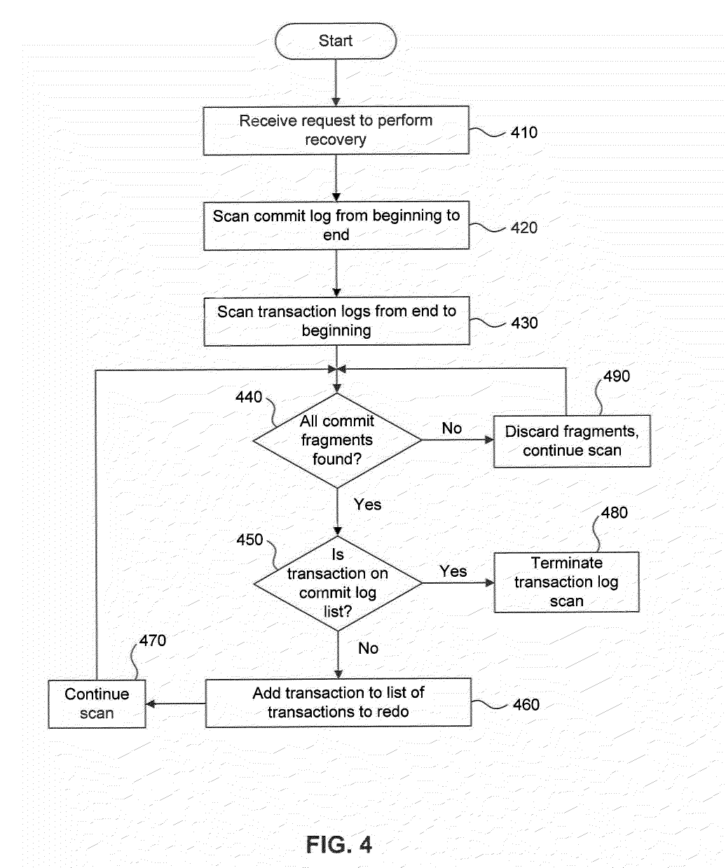

FIG. 4 is a flow diagram of a method 400 for building a list of transactions for a recovery process for an in-memory column-oriented database system. Method 400 may be implemented by, for example and without limitation, database server 110 of FIG. 1. Method 400 begins at step 410.

At step 410, a request to perform recovery of the in-memory database system is received. The request may be received automatically upon a system restart after a crash, or may be provided manually by an administrative user.

At step 420, the commit log is scanned to identify a list of committed transactions that must be redone. The commit log is scanned from the first transaction entry to the last transaction entry. If a commit is found during step 420, the transaction is considered to be fully committed. However, because the commit log is written to in a lazy, non-blocking fashion, it does not necessarily contain all committed transactions that must be redone. Thus, method 400 proceeds to step 430.

At step 430, commit fragments in the transaction logs are scanned starting at the last commit fragment in each transaction log. As described above, commit fragments contain data representing how many other commit fragments exist for the same transaction. If commit fragments for a transaction are found, method 400 proceeds to decision block 440.

At decision block 440, the database system determines whether all commit fragments for the transaction can be found. If all commit fragments for a transaction cannot be found, method 400 proceeds to step 490, where the commit fragments are discarded, and the transaction log scan continues.

If all commit fragments for a transaction can be found and the transaction can be properly identified, method 400 proceeds to decision block 450. At decision block 450, the transaction having all commit fragments identified at decision block 440 is compared to the transactions found from the commit log scan of step 420. If, at decision block 450, the transaction found from the commit fragment scan of step 440 exists on the list of transactions of step 420, then method 400 proceeds to step 480 and the transaction log scan terminates. Once such a transaction is found, the database system can report with confidence that the transaction, and all that preceded it, were in the commit log and were added to the list of transactions to redo.

If the transaction identified at step 440 does not exist on the list, method 400 proceeds to step 460. At step 460, the transaction is added to the list of transactions that must be redone. At step 470, the transaction log scan continues, and method 400 returns to decision block 440.

By scanning the commit and transaction logs in this way, all committed transactions can be found efficiently. In an embodiment, the “undo” phase is no longer necessary, thereby making recovery quicker. In an embodiment, once all committed transactions are found, the database system redoes each necessary operation.

An example operation of method 400 can be further understood with reference to FIG. 3 described above. After a request to perform recovery is received in accordance with step 410, the commit log 303 is scanned to identify committed transactions in accordance with step 420. For example, commit C1 is identified in accordance with step 420. in accordance with step 430, the log streams are scanned from the end to the beginning to identify additional transactions that must be redone. In accordance with decision block 440, the database system determines that all commit fragments for transaction T3 cannot be found, and thus those commit fragments are discarded, and the scan continues. In accordance with decision block 440, the database system then determines that all commit fragments for transaction T2 can be found in log streams 301a-301c.

Thus, in accordance With decision block 450, transaction T2 is compared to the list of transactions previously created. Because T2 does not exist on the it is added as an additional transaction that must be redone in accordance With step 470. In accordance with step 480, the scan continues, and in accordance with decision block 440, the database system determines that all commit fragments for transaction T1 can be found in log streams 301a-301c. At decision block 450, the database system determines that transaction T1 is already on the list of transactions that must be redone. Accordingly, the transaction log scan terminates in accordance with step 460. All transactions that must be redone are thus identified.

The recovery process typically begins by reading (fetching) a page from disk, redoing the operations on that particular page, and then fetching the next page that has operations that must be redone. Because disk reads take a significant amount of time, one technique to optimize the recovery process involves pre-fetching multiple pages at once. In an embodiment, each log maintains an identity page that includes a log page list, or an ordered list of pages used in that particular log. The log page list is a compressed, sequenced list of pages used by that particular log stream. During recovery, this log page list can be used to pre-fetch pages from disk that must be modified. In a multi-processor or multi-core system, one processor or thread can be dedicated to reading the log page list and fetching necessary pages, while other processors or threads can perform the actual redo process.

### Computer System

Various aspects of the embodiments described above can be implemented by software, firmware, hardware, or any combination thereof FIG. 1 illustrates a system 100 which may include one or more computer systems, including database server 110, in which embodiments, or portions thereof, may be implemented as computer-readable code. Various aspects of the embodiments are described in terms of an exemplary computer system 500. For example, database system 110 may be described in terms of being implemented using one or more computer systems 500.

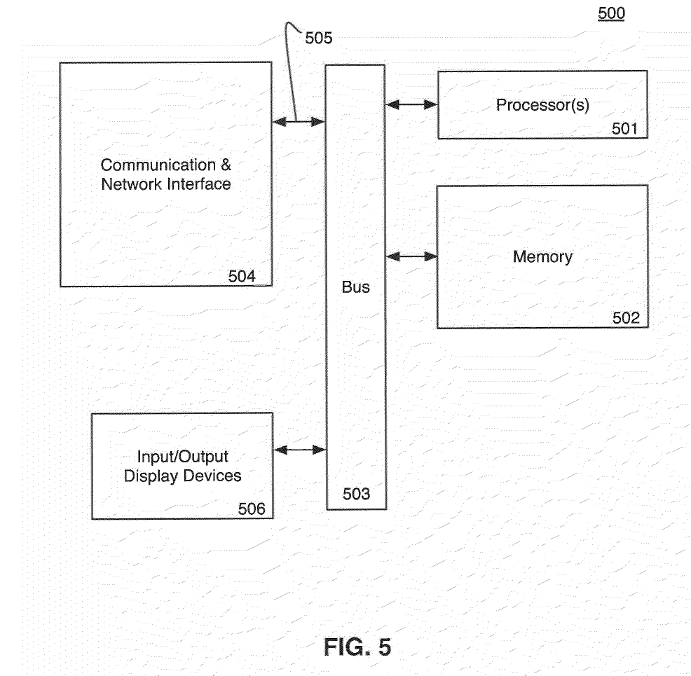

FIG. 5 illustrates an exemplary computer system 500. Computer system 500 may thus include one or more processors 501. Processor(s) 501 may be a special purpose processor or a general purpose processor. Processor(s) 501 may be connected to communication infrastructure, such as, for example, a bus 503 and or network. Computer system 500 may further include memory 502, which may include random access memory (RAM) and may also include secondary memory. Secondary memory may include, for example, a hard disk drive, a removable storage drive, and or a memory stick. A removable storage drive may comprise a floppy disk drive, magnetic tape drive, optical disk drive, flash memory, or the like. As will be appreciated by persons skilled in the relevant arts, a removable storage unit includes a computer usable storage medium having stored therein computer software and/or data. According to some embodiments, secondary memory may include similar means for allowing computer programs or other instructions to be loaded into computer system 500 which may include, for example, a removable storage unit and associated interface. Examples include a program cartridge and cartridge interface (such as, for example, may be found in a video game device), a removable memory chip (such as, for example, an EPROM or PROM) and associated socket, and other removable storage units and interfaces which allow software and data to be transferred from a removable storage Unit to computer system 500.

Computer system 500 includes a communications and network interface 504. Communication and network interface 504 may interface with remote sites, nodes, and or other networks via wired or wireless connections. Communication and network interface 504 enables computer system 500 to communicate over networks or mediums such as LANs, WANs the Internet; etc, Communication and network interface 504 may enable software and or data to be transferred between computer system 500 and external devices, nodes, and networks. Communications and network interface 504 may further include a modem, a communications port, a PCMCIA slot and card, or the like.

Software and data transferred via communications and network interface 504 may take the form of signals which may be electronic, electromagnetic, optical, or other signals capable of being received by communication and network interface 504. These signals are provided to communication and network interface 504 via a communication path 505. Communication path 505 carries signals and may be implemented using wire or cable, fiber optics, a phone line, a cellular phone link, an RF link or any other communications channels.

In this document, the terms “computer program medium” and “computer usable medium” and “computer readable medium” are used to generally refer to media such as a removable storage unit, a removable storage drive, and or a hard disk installed in a hard disk drive. Signals carried over communication path 505 may also embody the logic described herein. Computer program medium and computer usable medium may also refer to memories, such as memory 502, which may be memory semiconductors (e.g. DRAMs, etc.). These computer program products are means for providing software to computer system 500.

Computer programs (also called computer control logic) may be stored in memory 502. Computer programs may be executed by processor 501. Computer programs may also be received via communication and network interface 504 and executed locally, remotely, and or in a distributed manner utilizing the capabilities of computer system 500 to receive, store, process, and execute.

Such computer programs, when executed, enable computer system 500 to implement various embodiments discussed herein. Furthermore, such computer programs, when executed, enable processor 501 to implement the processes of embodiments, such as the steps in methods illustrated by flowcharts discussed. Thus, such computer programs may represent controllers of the computer system 500. Where an embodiment is implemented using software, such software may be stored in a computer program product and loaded into computer system 500 using a removable storage drive, interfaces, a hard drive, and or communication and network interface 504, for example.

Computer system 500 may also include input/output/display devices 506, such as keyboards, monitors, pointing devices, etc. Computer system 500 may interface with various device inputs and outputs (“I/O”), such as, for example, a display monitor, a keypad, or a touchscreen display, and any combination thereof. For example, computer system 500 may take the form of a personal computer, a mobile device, or any device having a display and processing capabilities.

Various embodiments are also directed to computer program products comprising software stored on any computer useable medium. Such software, when executed in one or more data processing device(s), causes a data processing device(s) to operate as described herein. Embodiments may employ any computer useable or readable medium, known now or in the future. Examples of computer useable mediums include, but are not limited to primary storage devices (e.g., such as any type of random access memory), secondary storage devices (e.g., such as hard drives, floppy disks, CD ROMS, ZIP disks, tapes, magnetic storage devices, optical storage devices, MEMS, nanotechnological storage device, etc.), and communication mediums (e.g., such as wired and wireless communications networks, local area networks, wide area networks, intranets, etc.).

Reading this description, it will become apparent to a person skilled in the relevant art how to implement these embodiments using other computer systems and/or computer architectures. Embodiments may further operate with software, hardware, and/or operating system implementations other than those described herein. Therefore, any software, hardware, and operating system implementations suitable for performing the functions described herein can be used.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit in any way. Various embodiments are described herein with the aid of functional building blocks for illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific disclosed embodiments will so fully reveal the general nature of the disclosed embodiments that others can, by applying knowledge within the skill of the art, readily modify and/or adapt for various applications such specific embodiments, without undue experimentation. Therefore, such adaptations and modifications are intended to be within the meaning and range of equivalents of the disclosed embodiments, based on the teaching and guidance presented herein. It is to be understood that phraseology or terminology is for the purpose of description and not of limitation, such that the terminology or phraseology of the specification is to be interpreted by the skilled artisan in light of the teachings and guidance.

The breadth and scope of the disclosed embodiment should not be limited by any of the above-described exemplary embodiments, but should be defined only in accordance with the following claims and their equivalents.

What is claimed is:

1. A computer-implemented method in a database system, comprising:
receiving, from a client, a request to perform a transaction, the transaction requiring two or more database tables in an in-memory column-oriented data store;
performing the transaction on each of the two or more database tables, wherein performance of the transaction generates two or more commit fragments corresponding to each of the two or more database tables; and
updating a transaction log and a commit log according to the generated two or more commit fragments.

2. The method of claim 1, wherein updating a transaction log further comprises storing each commit fragment in a transaction log for each of the two or more database tables.

3. The method of claim 2, further comprising acknowledging completion of the transaction to the client after storing all commit fragments.

4. The method of claim 2, wherein updating a commit log further comprises storing a commit record for the transaction in a commit log after all commit fragments have been stored.

5. The method of claim 1, further comprising:
receiving a request to perform recovery of the in-memory data store;
scanning the commit log to identify a first list of transactions that were committed before a system crash, wherein the scan is performed from beginning to end of the commit log;
scanning the transaction togs to identify a second list of transactions were committed before the system crash, wherein the scan is performed from end to beginning of the transaction logs;
terminating the scanning of the transaction logs when the scanning of the transaction logs identifies a transaction present the first list of transactions that must be redone; and
appending each transaction on the second list of transactions to the first list of transactions to create a list of transactions that must be redone.

6. The method of claim 5, wherein each transaction on the second list of transactions is identified based on a complete set of commit fragments for the transaction.

7. The method of claim 5, further comprising redoing each transaction on the list of transactions that must be redone.

8. A system, comprising:
one or more processors; and
a memory, the memory storing instructions that, when executed by the one or more processors, cause the one or more processors to:
receive, from a client, a request to perform a transaction, the transaction requiring two or more database tables in an in-memory column-oriented data store;
perform the transaction on each of the two or more database tables, wherein performance of the transaction generates two or more commit fragments corresponding to each of the two or more database tables; and
update a transaction log and a commit log according to the generated two or more commit fragments.

9. The system of claim 8, further comprising one or more disk based storage devices, and wherein the memory farther stores instructions that cause the one or more processors to store each commit fragment in a transaction log for each of the two or more database tables on the one or more disk based storage devices.

10. The system of claim 9, wherein the memory further stores instructions that cause the one or more processors to acknowledge completion of the transaction to the client after storing all commit fragments.

11. The system of claim 9, wherein the memory farther stores instructions that cause the one or more processors to store the commit log on the one or more disk based storage devices.

12. The system of claim 8, wherein the memory further stores instructions that cause the one or more processors to:
receive a request to perform recovery of the in-memory data store;
scan the commit log to identify a first list of transactions that were committed before a system crash, wherein the scan is performed from beginning to end of the commit log;
scan the transaction logs to identify a second list of transactions were committed before the system crash, wherein the scan is performed from end to beginning of the transaction logs;
terminate the scanning of the transaction logs when the scanning of the transaction logs identifies a transaction present the first list of transactions that must be redone; and
append each transaction on the second list of transactions to the first list of transactions to create a list of transactions that must be redone.

13. The system of claim 12, wherein each transaction on the second list of transactions is identified based on a complete set of commit fragments for the transaction.

14. The system of claim 12, wherein the memory further stores instructions that cause the one or more processors to redo each transaction on the list of transactions that must be redone.

15. A computer-readable medium haying instructions stored thereon, the instructions when executed causing at least one computing device to perform operations, the operations comprising:
receiving, from a client, a request to perform a transaction, the transaction requiring two or more database tables in an in-memory column-oriented data store;
performing the transaction on each of the two or more database tables, wherein performance of the transaction generates two or more commit fragments corresponding to each of the two or more database tables; and
updating a transaction log and a commit log according to the generated two or more commit fragments.

16. The computer-readable medium of claim 15, wherein updating a transaction log further comprises storing each commit fragment in a transaction log for each of the two or more database tables.

17. The computer-readable medium of claim 16, the operations further comprising acknowledging completion of the transaction to the client after storing all commit fragments.

18. The computer-readable medium of claim 16, wherein updating a commit log further comprises storing a commit record for the transaction in a commit log after all commit fragments have been stored.

19. The computer-readable medium of claim 15, the operations further comprising:
receiving a request to perform recovery of the in-memory data store;
scanning the commit log to identify a first list of transactions that were committed before a system crash, wherein the scan is performed from beginning to end of the commit log;
scanning the transaction logs to identify a second list of transactions were committed before the system crash, wherein the scan is performed from end to beginning of the transaction logs;
terminating the scanning of the transaction logs when the scanning of the transaction logs identifies a transaction present the first list of transactions that must be redone; and
appending each transaction on the second list of transactions to the first list of transactions to create a list of transactions that must be redone.

20. The computer-readable medium of claim 15, wherein each transaction on the second list of transactions is identified based on a complete set of commit fragments for the transaction.
